(19) United States
(12) Patent Application Publication
(10) Pub. No.: US 2026/0073430 A1
(43) Pub. Date: Mar. 12, 2026

(54) Personalized Customer Surveys Using Machine Learning

(71) Applicant: Oracle International Corporation, Redwood Shores, CA (US)

(72) Inventors: David Mor, Pittsford, NY (US); Prabakar Paulsami, Redwood City, CA (US); Kent Olen Swartz, Leesburg, VA (US); Naveen Thulasidharan, Trivandrum (IN); Nithin Nassar, Trivandrum (IN)

(73) Assignee: Oracle International Corporation, Redwood Shores, CA (US)

(21) Appl. No.: 18/985,248

(22) Filed: Dec. 18, 2024

Related U.S. Application Data
(60) Provisional application No. 63/691,554, filed on Sep. 6, 2024.

(51) Int. Cl. G06Q 30/0282

(52) U.S. Cl. CPC G06Q 30/0282

(57) ABSTRACT

Techniques for generate personalized satisfaction surveys for particular customers are disclosed. A system tracks interactions and events involved in a service request received from a customer. The tracking includes logging interactions between the customer, customer service agents, and service teams. Using the logged information, the system engineers prompts for a large language model to generate a satisfaction survey that includes a survey question tailored to the customer's particular service request. After the system receives a response to the survey, the system submits the content to a machine learning model trained to determine a satisfaction score for the survey.

### BENEFIT CLAIMS; RELATED APPLICATIONS; INCORPORATION BY REFERENCE

This application claims the benefit of U.S. Provisional Patent Application 63/691,554, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to customer service systems. In particular, the present disclosure relates to improving the accuracy and computational efficiency of customer service systems.

### BACKGROUND

Organizations use surveys to collect feedback from customers. The surveys typically include a series of questions that are designed to obtain insights into the customers' experiences, preferences, and satisfaction levels with an organization's products, services, or brands. For example, after providing a service to a customer, an organization may send the customer a satisfaction survey that includes one or more questions regarding various aspects of the service. The results of the survey are referred to as a customer satisfaction score. Organizations use the survey results to make decisions about product development, service improvements, and marketing strategies. One approach is to use the same satisfaction survey for all customers, which provides homogenous results but is not tailored to each customer's unique experience.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a functional block diagram of an example service management architecture in accordance with one or more embodiments;

FIG. 1B illustrates a system block diagram of an example service management system in accordance with one or more embodiments;

FIGS. 2A, 2B, and 2C illustrate an example set of operations for generating and evaluating personalized customer satisfaction surveys in accordance with one or more embodiments;

FIG. 3A illustrates an example prompt in accordance with one or more embodiments;

FIG. 3B illustrates an example prompt response in accordance with one or more embodiments;

FIG. 3C illustrates an example survey in accordance with one or more embodiments;

FIG. 4 illustrates a machine learning engine in accordance with one or more embodiments;

FIG. 5 illustrates the operation of a machine learning engine in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES & IMPROVEMENTS
3. SERVICE MANAGEMENT ARCHITECTURE
4. SERVICE MANAGEMENT SYSTEM
5. GENERATING AND EVALUATING PERSONALIZED CUSTOMER SATISFACTION SURVEYS
6. EXAMPLE OF PROMPT ENGINEERING AND SURVEY GENERATION
7. MACHINE LEARNING ARCHITECTURE
8. HARDWARE OVERVIEW
9. MISCELLANEOUS; EXTENSIONS

### 1. GENERAL OVERVIEW

One or more embodiments generate satisfaction surveys for particular customers that are personalized to the customers' interactions with a customer service system. The system tracks interactions and events involved in a service request received from the customer. The tracking includes logging interactions between the customer, customer service agents, service teams, and the like. The system also logs metadata describing the interactions. Using the logged interactions and metadata, the system engineers a prompt for a large language model (LLM) to generate a satisfaction survey that includes questions tailored to the customer's particular service request. After the LLM generates the customer satisfaction survey, the system transmits the survey to the customer for completion.

One or more embodiments train a machine learning model to determine a customer satisfaction score for the personalized satisfaction survey completed by the customer along with an explanation of the satisfaction score. The system receives the completed survey from the customer and submits the survey to the machine learning model trained to score the survey. The machine learning model generates an overall satisfaction score for the particular survey and an explanation of the score. The machine learning model generates satisfaction scores that are compatible with each other even though they are based on different personalized satisfaction surveys. Using the machine learning model to generate satisfaction scores allows for personalized satisfaction surveys to serve as the basis for metrics that require heterogeneous scores, such as averages, trends, etc.

One or more embodiments described in this Specification and/or recited in the claims may not be included in this General Overview section.

### 2. PRACTICAL APPLICATIONS, ADVANTAGES & IMPROVEMENTS

Once or more embodiments enhance the operation and efficiency of business management platforms by using artificial intelligence (AI) to generate personalized customer satisfaction surveys. One or more embodiments apply AI to generate surveys that include relevant questions targeted to particular customer service requests. The surveys include personalized questions directed to moments or events that are substantially more likely to elicit a customer response than standard survey questions. Additionally, the personalized questions elicit more meaningful feedback than standard survey questions. As a result, the system generates high quality datasets that include more accurate data and patterns than standard surveys.

One or more embodiments enhance the operation and efficiency of machine learning models that depend on customer feedback, by training such models using datasets produced as described above. For example, a dataset generated using the personalized surveys may be used as training data to improve the performance of one or more machine learning model used to make predictions for product development, service improvements, and marketing strategies. The higher quality datasets more effectively train these machine learning models by reducing noise or irrelevant information. As a result, training involves fewer iterations to converge outputs of the machine learning models to an optimal solution. In general, fewer iterations means that fewer computing resources (e.g., processing cycles, memory, storage, network bandwidth, etc.) are needed to reach a solution. Thus, one or more embodiments improve the functioning of the underlying computer system(s) by reducing the computational burden of training the machine learning model(s). Furthermore, the high quality datasets are more representative of the real-world scenarios the machine learning models are intended to predict. Accordingly, the higher quality datasets generate more accurate machine learning models.

Additionally, one or more embodiments use AI to analyze customer satisfaction survey results to identify patterns and trends in customer responses. The AI analysis may identify patterns in the survey data that are unrecognizable by a human. These insights can then be integrated into various operational areas, such as customer support, product development, and marketing, enabling the system to respond more rapidly to customer needs and preferences.

### 3. SERVICE MANAGEMENT ARCHITECTURE

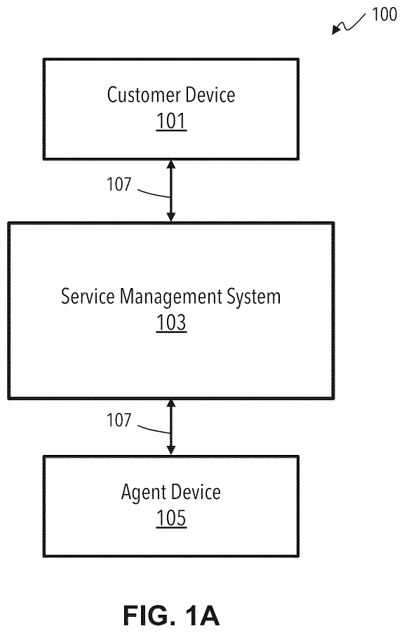

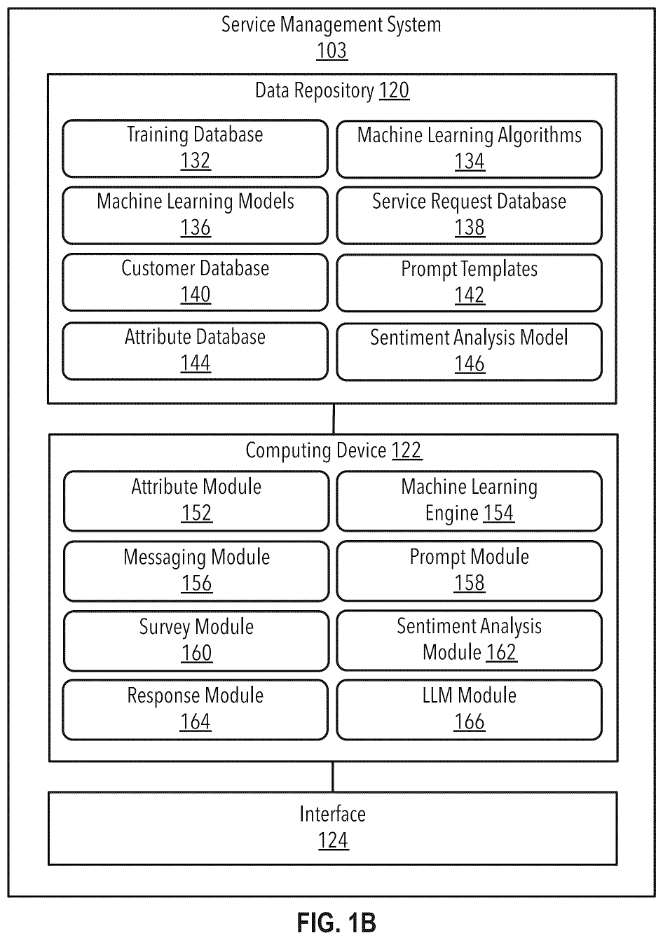

FIG. 1A illustrates an example service system architecture 100 in accordance with one or more embodiments. As illustrated in FIG. 1A, the architecture 100 includes a customer device 101, a service management system 103, and an agent device 105 that are communicatively connected, directly or indirectly, via one or more communication links 107. In one or more embodiments, the architecture 100 includes more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Embodiments of the architecture 100 include a computing environment that manages customer service processes, such as customer inquiries, issues, and requests. Via the customer device 101, a customer may communicate electronic messages directly or indirectly with the service management system 103 and the agent device 105 using the communication links 107 and various communication channels, such as email, phone, chat, and social media. For example, the customer device 101 may directly communicate with the agent device 105. Additionally, or alternatively, the customer device 101 may indirectly communicate with the agent device 105 via the service management system 103. In either case, the service management system 103 logs the messages communicated among the customer device 101, the service management system 103, and the agent device 105.

The communication links 107 include wired and/or wireless information communication channels, such as the Internet, an intranet, an Ethernet network, a wireline network, a wireless network, a mobile communications network, and/or another communication network. For example, the customer device 101 may communicate with the service management system 103 and the agent device 105 via the Internet by exchanging data packets through a Wi-Fi or cellular data network connection.

The customer device 101 includes one or more computing devices communicatively linked with the service management system 103 and the agent device 105. The term “computing device” generally refers to any hardware device that includes a processor configured to execute computer-readable program instructions. The customer device 101 may be, for example, a personal computer, a workstation, a server, a mobile device, and/or other processing device capable of implementing and/or executing software, applications, program instructions, etc. One or more embodiments of the customer device 101 present a user interface allowing a user to access, perceive, and interact with the service management system 103 and/or the agent device 105. For example, the customer device 101 may execute software, such as a Web browser or client application, that generates a computer-user interface that allows a user of the customer device 101 to interact with an agent directly via the agent device 105 or indirectly via the service management system 103.

The service management system 103 includes one or more computing devices that manage and track interactions between an organization, customers, and customer service agents. The computing device may refer to a physical device executing an application or a virtual machine. Examples of the service management system 103 include a computer, a desktop, a server, a web server, or a mainframe. The service management system 103 captures customer messages and data from various sources and devices, and catalogs the messages and data in a searchable format.

The agent device 105 includes one or more computing devices communicatively linked with the customer device 101 and the service management system 103. The agent device 105 may be a personal computer, a workstation, a server, a mobile device, and/or other processing device capable of implementing and/or executing software, applications, program instructions, etc. One or more embodiments of the agent device 105 present a user interface allowing a customer service agent to access, perceive, and interact with a customer via the customer device 101.

### 4. SERVICE MANAGEMENT SYSTEM

FIG. 1B is a block diagram illustrating an example service management system 103 in accordance with one or more embodiments. The service management system 103 includes hardware and software that perform processes and functions described herein. In one or more embodiments, the service management system 103 includes more or fewer components than the components illustrated in FIG. 1B. The components illustrated in FIG. 1B can be local to or remote from each other. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the service management system 103 include a data repository 120, a computing device 122, and an interface 124. The data repository 120 includes any type of storage unit and/or device (e.g., a file system, database, collection of tables, or other storage mechanism) for storing data. Furthermore, the data repository 120 may include multiple different storage units and/or devices. The multiple different storage units and/or devices may or may not be of the same type or located at the same physical site. Furthermore, the data repository 120 can be implemented or executed on the same computing system as the service management system 103. Additionally, or alternatively, the data repository 120 may be implemented or executed on a computing system separate from the service management system 103. The data repository 120 can be communicatively coupled, wired and/or wirelessly, to the service management system 103 via a direct connection or via a network.

In one or more embodiments, the data repository 120 stores a training database 132, machine learning algorithms 134, machine learning models 136, a service request database 138, a customer database 140, prompt templates 142, an attribute database 144, and a sentiment analysis model 146. The training database 132 is one or more data structures storing organized sets of training data for training machine learning models such as the machine learning models 136. Based on the training data, a machine learning model learns patterns and correlations in the training data that would be unapparent or unrecognizable to humans. As described in greater detail below, the training data may include content, metadata, and corresponding prompts.

The machine learning algorithms 134 are one or more algorithms that iteratively train machine learning models to map a set of input variables to one or more output variables. In particular, the machine learning algorithms 134 are configured to train the machine learning models 136 to generate customized surveys and evaluate survey responses. Embodiments of the machine learning algorithms 134 store an algorithm that can be iterated to train a target model f that best maps a set of input variables to an output variable using the training data. The training data includes datasets and associated labels. The datasets are associated with input variables for the target model f. The associated labels are associated with the output variable of the target model f. The training data may be updated based on, for example, feedback on predictions by the target model f and accuracy of the current target model f. Updated training data is fed back into the machine learning algorithm that, in turn, updates the target model f.

A machine learning algorithm 134 generates the target model f such that the target model f best fits the datasets of training data to the labels of the training data. Additionally, or alternatively, the machine learning algorithm 134 generates a target model f such that when the target model f is applied to the datasets of the training data, a maximum number of results determined by the target model f matches the labels of the training data. Different target models may be generated based on different machine learning algorithms and/or different sets of training data.

A machine learning algorithm 134 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The machine learning models 136 are software trained to make predictions, recognize patterns, or perform tasks without being explicitly programmed for specific decisions. One or more of the machine learning models 136 is trained to generate prompts for an LLM to cause the LLM to generate customized survey questions based on customer interactions and metadata of the interactions. Additionally, one or more of the machine learning models 136 is trained to determine an overall satisfaction score for the survey and an explanation of the satisfaction score.

The service request database 138 is one or more data structures recording interactions between customers, agents, and/or the service management system 103. The service request database 138 stores the content of electronic messages, notes, and other communications captured by the service management system 103 along with corresponding metadata. The messages may be, for example, content and metadata of customer inquiries, agent responses, inter-organization communications, and other such messages. The content may include text and multimedia data included in a message. The metadata may include the date, time, customer identifiers, agent identifiers, message sources, incident priorities, and statuses. The metadata may also include performance information, such as response times, sentiment scores, sentiment classifications, number of agent transfers, number of escalations, resolution time, and customer effort score.

The customer database 140 includes one or more data structures that store and organize customer information. The customer information may include customer profiles, such as names, descriptions, contact information, and histories. The customer information may also log previous service requests, surveys, survey responses, messages, notes, and other data related to individual customers.

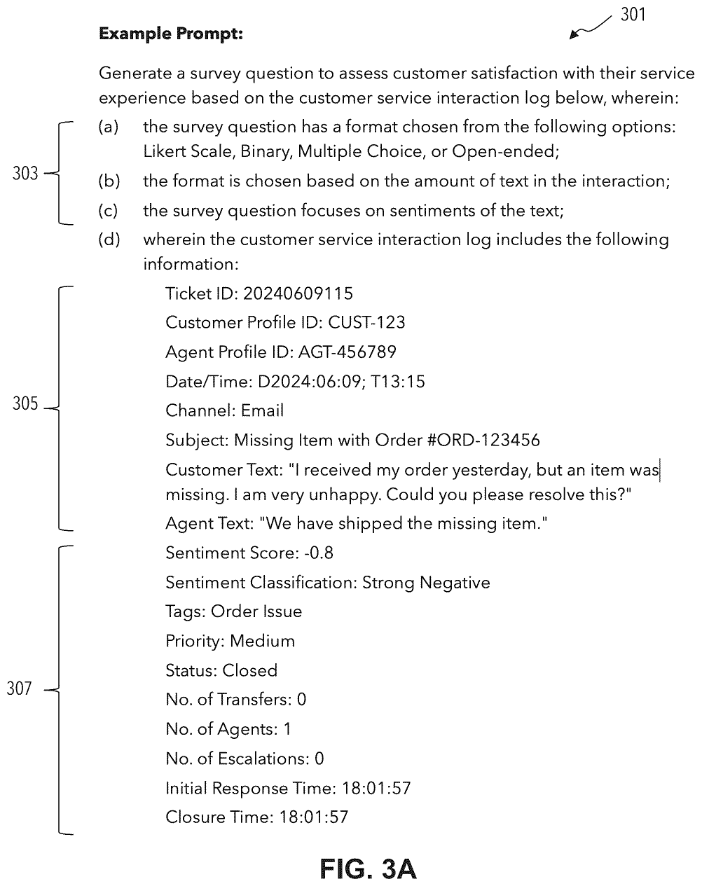

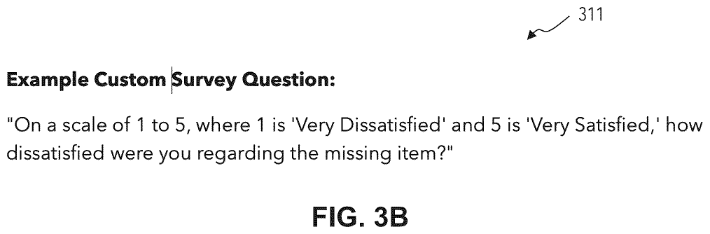

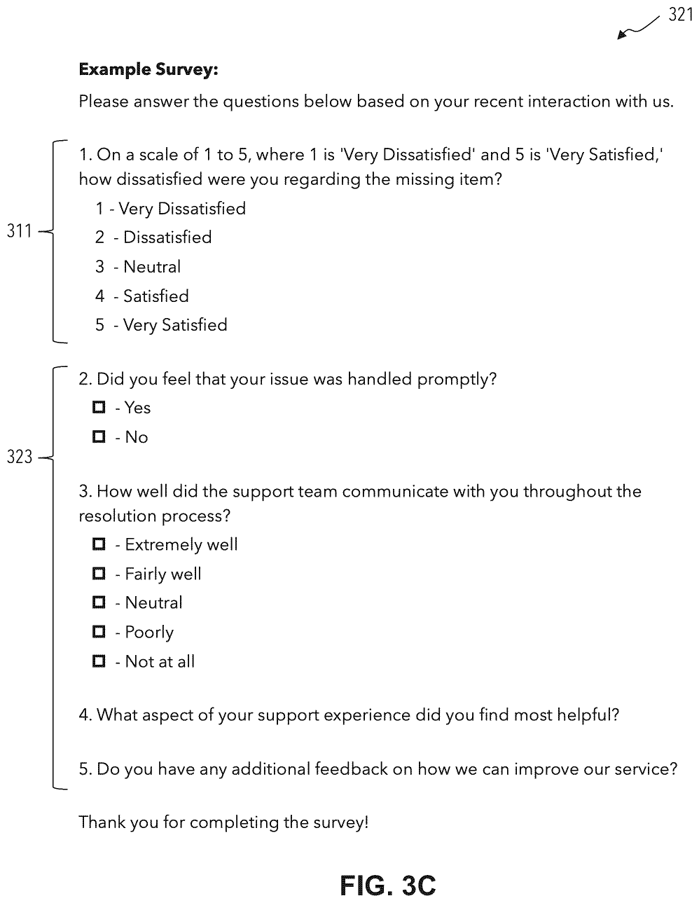

The prompt templates 142 are one or more data structures storing templates for prompting an LLM to generate specific types of responses from the LLM. One or more of the prompt templates 142 causes the LLM to generate survey questions tailored for particular customers based on, for example, individual customers' interactions with a customer service system. For example, FIG. 3A illustrates an example prompt template 301 including one or more fields, such as survey question types, format, target interaction, and interaction information and performance information.

The attribute database 144 stores attributes used by the machine learning models 136. The attributes include data extracted relevant data from other databases, such as the training database 132, the service request database 138, and the customer database 140. The attributes are stored in a structured format compatible for input to the machine learning models 136. Examples of stored attributes may include customer information (such as profiles, demographics and identifiers), service request details (such as resolution time and interaction history), and training data features (such as labeled prompts outputs).

The sentiment analysis model 146 is software trained to assess and interpret the emotional tone within a conversation's content. The sentiment analysis model 146 evaluates content and identifies portions (e.g., phrases, sentences, or passages) to determine portions associated with positive or negative sentiment. Embodiments of the sentiment analysis model 146 recognize linguistic patterns, emotional indicators, and contextual cues that distinguish positive expressions (e.g., praise or satisfaction) from negative expressions (e.g., complaints or frustration) using natural language processing (NLP) techniques and machine learning algorithms. Based on the evaluation, the sentiment analysis model 146 assigns the positive or negative portions a score representing the sentiment's strength. Additionally, sentiment analysis model 146 may aggregate the scores to determine an overall sentiment score for the content.

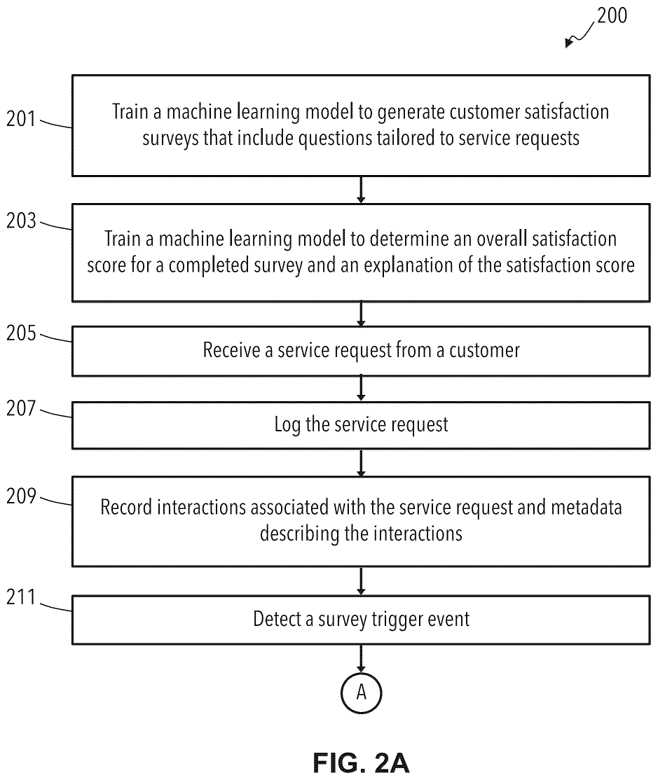

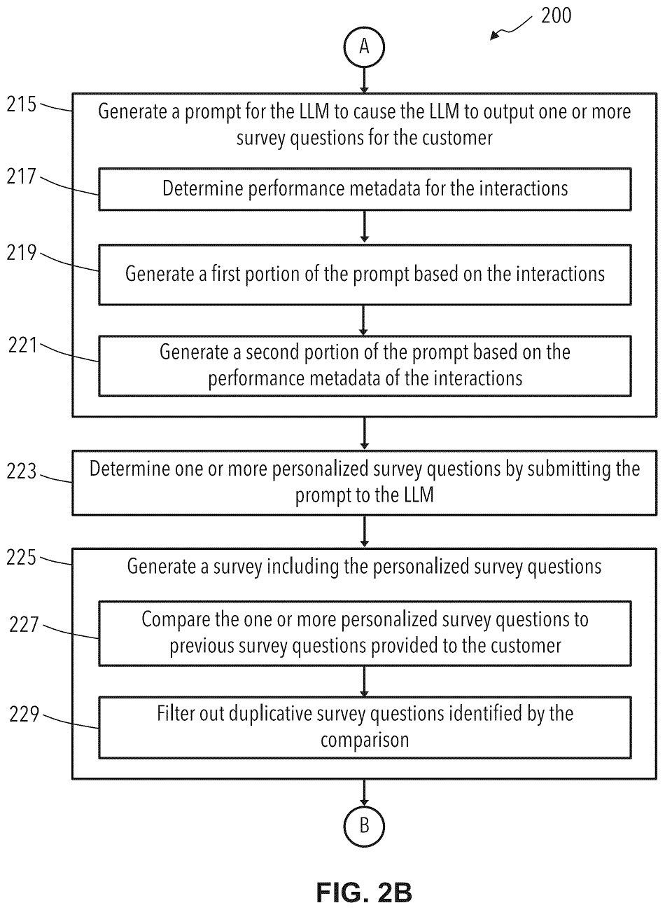

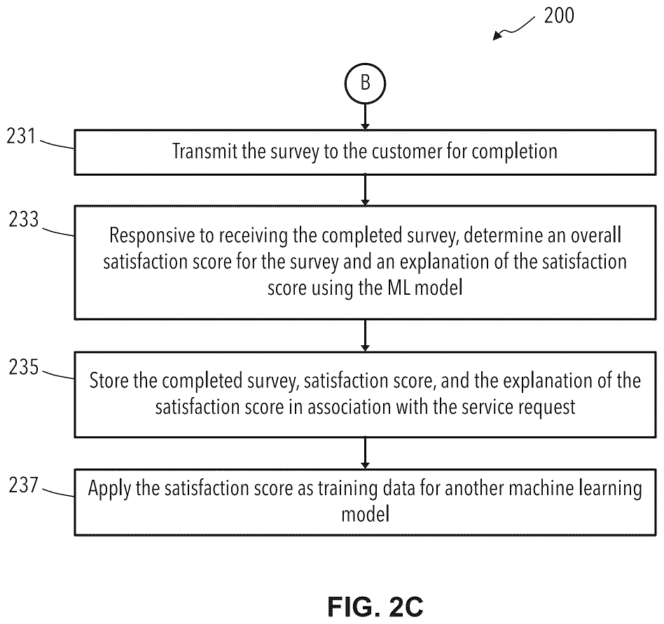

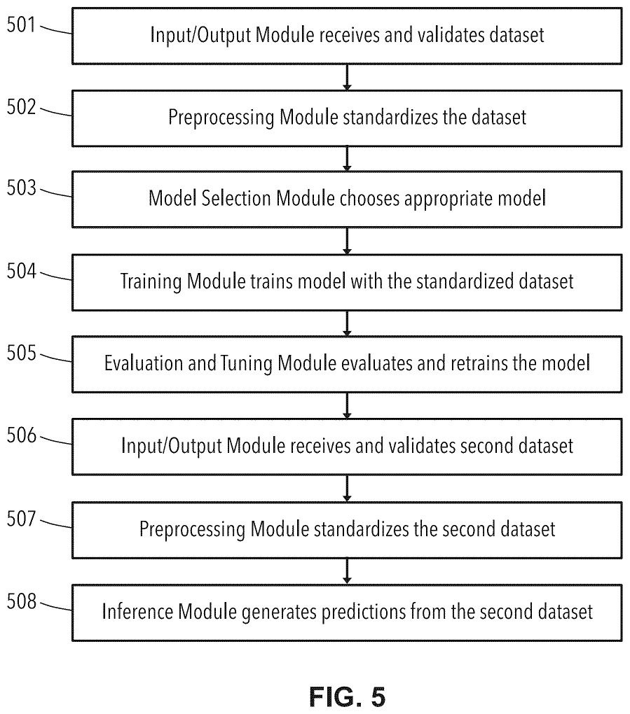

In one or more embodiments, the computing device 122 includes hardware and/or software configured to perform operations described herein. Example operations are described below with reference to FIGS. 2A, 2B, 2C, and 5. The computing device 122 executes computer-readable program instructions, such as an operating system and application programs, that are stored in memory devices and/or the storage system. Additionally, the computing device 122 executes program instructions of an attribute module 152, a machine learning engine 154, a messaging module 156, a prompt module 158, a survey module 160, a sentiment analysis module 162, a response module 164, and an LLM module 166.

The attribute module 152 generates attributes for the machine learning model 136 and stores the attributes in the attribute database 144. The attribute module 152 obtains data from the training database 132, the service request database 138, and/or the customer database 140 to generate the attributes for processing by the machine learning models 136. For example, the attribute module 152 may extract, standardize, and organize the attributes in the attribute database 144.

The machine learning engine 154 may execute a machine learning algorithm 134 to train a machine learning model 136. For example, the machine learning engine 154 may retrieve attributes stored by the attribute database 144 and convert the attributes to feature vectors to generate computer-readable features optimized for the machine learning algorithms 134 and/or the machine learning models 136. Using the feature vectors, the machine learning engine 154 trains a machine learning model to create prompts for an LLM, such as Generative Pre-trained Transformer (GPT) or Bidirectional Encoder Representations from Transformers (BERT) for generating survey questions.

The messaging module 156 captures catalogs electronic messages communicated between the service management system 103, customers, and/or agents. Example electronic messages include emails, text messages, chat messages, voicemails, video messages, or social media posts. Individual electronic messages may be part of a dialog involving, for example, a customer service request, agent responses, or updates on service requests. The messaging module 156 logs individual messages and corresponding metadata as part of the conversation history.

The prompt module 158 generates a prompt that, when submitted to an LLM, causes the LLM to output personalized survey questions for customer surveys. For a customer interaction, such as an email or chat involved in a service request, the prompt module 158 retrieves information from the service request database 138 and the customer database 140. In addition, the prompt module 158 may submit the content of the service request of the sentiment analysis module 162 to identify portions of the service request with positive or negative sentiment scores exceeding a threshold. Furthermore, the prompt module 158 may invoke the attribute module 152 to extract specific attributes from the retrieved information. Moreover, the prompt module 158 may invoke one or more machine learning models 136 to create a prompt for an LLM. Furthermore, the prompt module 158 may invoke an LLM to generate survey questions.

The survey module 160 generates surveys for particular customers that include the survey question obtained by the prompt module 158. Generating a survey may include filtering out duplicate questions generated by the prompt module and/or that have previously been sent to the user in a past survey. For example, the service request database 138 may store past survey provided to customers for comparison. The survey module 160 may also combine the survey questions into a form for presentation to a customer. For example, the system may combine the generated survey questions with generic or standard survey questions in a web-based form along with instructions for completing the survey. Additionally, the survey module 160 may transmit the survey form to the customer via one or more communication channels.

The response module 164 evaluates survey responses received from customers. When a completed survey is received from a customer, the response module 164 may determine an overall satisfaction score based on survey responses, including handling narrative responses with NLP to capture sentiment and context. The response module 164 may uses attributes extracted from the survey responses to generate feature vectors and invoke a machine learning model trained to identify patterns correlating specific survey attributes with satisfaction levels. For example, the machine learning model may assign a satisfaction score along with an explanation of the score's derivation. The explanation may highlight key responses and comments that influenced the score as well as their relative weight or importance in the model's decision-making process.

Moreover, the response module 164 logs and indexes the survey data and score together with the customer's service request conversation. Some embodiments use the satisfaction score and related interaction data as training inputs for additional machine learning models that use satisfaction outcomes, customer interaction history, and service metadata as training data, identifying patterns and relationships in customer feedback. Based on the stored customer satisfaction data, one or more embodiments may generate recommendations, predict future customer satisfaction, and support decision-making related to product development, service improvements, or targeted marketing initiatives.

The LLM module 166 invokes and/or executes an LLM trained to understand and generate natural language. Some embodiments of the LLM module 166 locally execute the LLM. Some other embodiments interface with an externally executed LLM, such as GPT or BERT.

The interface 124 refers to hardware and/or software that facilitates communications between a user and agents. The interface 124 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, different components of interface 124 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 124 is specified in one or more other languages, such as Java, C, or C++.

### 5. GENERATING AND EVALUATING PERSONALIZED CUSTOMER SATISFACTION SURVEYS

FIGS. 2A, 2B, and 2C illustrate an example set of operations 200 for generating and evaluating personalized customer satisfaction surveys. One or more operations illustrated in FIGS. 2A, 2B, and 2C may be modified, rearranged, or omitted. Accordingly, the particular sequence of operations illustrated in FIGS. 2A, 2B, and 2C should not be construed as limiting the scope of one or more embodiments.

The system trains a machine learning model to generate customer satisfaction survey questions tailored to customer service requests (Operation 201). One or more embodiments train the machine learning model to generate prompts that, when submitted to an LLM, cause the LLM to generate survey questions personalized for a customer. Some other embodiments train a machine learning model to generate survey questions based on attributes of service requests. The machine learning model can be, for example, a neural network, a sequence-to-sequence model, a linear regression algorithm, or a random forest algorithm that learns patterns by analyzing the relationships between the attributes in the training data.

Training the machine learning model includes generating a training data set including attributes extracted from past satisfaction surveys for customer service requests. The system can extract the attributes from the past satisfaction surveys using NLP techniques and image recognition techniques such as optical character recognition (OCR). Extracting the attributes includes tokenizing text, converting words into numerical representations, and capturing the semantic meaning of the descriptions.

Generating the training data set also includes associating the extracted attributes with interaction data and metadata corresponding to the customer service requests. Interactions include communications associated with the handling of a service request. Example communications include telephone conversations and electronic messages exchanged among customers, customer service agents, service teams, and the like. The information extracted may be details of the communications, such as transcripts, notes, or summaries. The interaction information also describes events that occurred during the handling of a service request. Example events include changes in the status of the service request, billing, shipping parts or replacements, transfers between agents, and status elevations. The metadata includes information describing the interactions. Example metadata includes sources, timestamps, durations, communication channels, a customer identifier, agent identifiers, agent types, issue type, product or service types, and request status. The metadata may also include information quantifying the above metadata. For example, the metadata may indicate if one or more parameters exceed predetermined thresholds for sentiment score, response time, wait time, on-hold time, number of agents, and transfers between departments.

Generating the training data set also includes engineering prompts for survey questions. For example, a subject matter expert may engineer prompts appropriate for a set of attributes extracted from the service requests. Engineering the prompts may also include defining relationships between the prompts and the types of survey questions to be generated. For example, the system may map various prompt structures to corresponding question formats, such as Likert scale questions, binary questions, multiple-choice questions, or open-ended questions. The mapping may be performed using predefined templates, rules, or examples that instruct the LLM on how to handle different prompt scenarios.

The machine learning model is trained to generate LLM prompts using the training data as inputs and engineered prompts as labels. Training the machine learning model includes computing feature vectors using the training data and labels and feeding the feature vectors from the training dataset to a machine learning algorithm. The system adjusts internal parameters of the machine learning algorithm to minimize the difference between the prompts generated by the LLM and the prompts in the training dataset. By doing so, the algorithm learns to identify elements in the training data that are most likely to influence the prompt and survey questions. During training, the model is evaluated and adjusted. The system measures the accuracy of the model's predictions against the labeled data in the dataset. Additionally, the system may use a subset of the training data to verify that the output of the machine learning model is sufficiently accurate by comparing the generated prompts, subject lines, and tags output of the model to the verification examples. Evaluation metrics like Bilingual Evaluation Understudy (BLEU) Score or Recall-Oriented Understudy for Gisting Evaluation (ROUGE) score can be applied to assess the quality of the outputs.

Additionally, the system trains another machine learning model to determine an overall satisfaction score for a completed survey and an explanation of the satisfaction score (Operation 203). Training the machine learning model includes obtaining a training data set including past customer satisfaction survey responses that include question responses and overall satisfaction scores. For example, the system can maintain a library of past survey responses. The survey responses may include answers to individual questions and an overall satisfaction score for the individual surveys. The content of surveys may also include narrative responses to open-ended survey questions that the system extracts using NLP techniques.

The training data set may store the types of survey questions, the corresponding responses, and the overall satisfactions scores as attributes. Using these attributes as features, the system computes feature vectors with the satisfaction scores as labels for training a machine learning algorithm. The algorithm may be a linear regression model, a decision tree, a random forest model, or a neural network model. Training involves feeding the feature vectors from the training dataset to the model. During training, the model is iteratively evaluated and adjusted by measuring the accuracy of the model's predictions against the labeled data in the dataset. For example, metrics, such as mean squared error (for regression) or accuracy (for classification), are calculated to assess the model's accuracy. Additionally, after training, a subset of the training data can be used to verify that the machine learning model is sufficiently accurate by comparing the scores and explanations output of the model to the known scores and explanations of the training data.

The system receives a service request from a customer (Operation 205). Example service requests include communications initiated by customers to seek assistance, resolve an issue, or inquire about a product or service provided by an organization. A service request may seek assistance with, for instance, technical support, billing inquiries, or feedback. The service request may be received through one or more communication channels, such as telephone, email, chat, web page, voicemail, video message, social media, or the like. For example, the customer may submit the service request and its details via an email. The request may include customer details, such as account information, product details, and a description of the issue or inquiry.

The system logs the service request from the customer (Operation 207). Logging includes storing details, such as metadata information of the service requests, in a database or other storage system. The logged request may be referred to as an “incident” that includes the customer's identity, contact information, the type of request, a product or service, and a description of the request. Example incident types include technical support, billing inquiries, or product feedback. The metadata may include an identifier of the request, a communication channel, time/date of the service request, and an urgency of the service request. Additionally, the contextual information may include a history of previous interactions with the customer as well as product or service details related to the request.

The system records interactions associated with the service request and metadata describing the interactions (Operation 209). As previously described, the interactions can include communications among the customer, agents, support teams, different departments, etc. For example, an interaction may include communications as the agent works to advise, clarify, troubleshoot, and resolve the issue with the customer. The logged interaction may include transcripts, notes, or summaries of the communications and events that occurred during the interactions. Additionally, the system records metadata describing and quantifying the performance of individual interactions. As detailed above, example metadata includes various information, such as timestamps, durations, communication types, customer information, agent information, product or service information, and actions taken. Additionally, the metadata may include performance metadata derived from the above metadata that may be used, for example, to determine if any performance thresholds were exceeded.

The system detects a survey trigger event (Operation 211). The trigger event may be a change in the status of the service request, such as the system indicating the service request is resolved or closed, or an agent ends a call, chat, or email support session. Some embodiments trigger the survey generation based on specific rules or thresholds. For example, the system may initiate a survey if the service interaction meets certain criteria, such as an escalated case, a request with a long resolution time, or a high-value customer interaction. Additionally, surveys may be triggered by interactions that involve new product support or after a customer subscribes to or upgrades a service.

Referring to FIG. 2B, as indicated by off-page connector “A,” the system generates a prompt for an LLM to output a survey question for the customer based on the interactions and the metadata (Operation 215). Some embodiments prompt the LLM to generate a single survey question corresponding to a particular interaction or event. Some other embodiments prompt the LLM to generate multiple survey questions directed to one or more events. Engineering a prompt includes extracting information from the interactions and associated metadata. Some embodiments use prompt templates including predefined fields to be filled in with relevant information extracted from the interactions and associated metadata. Also, the system may apply one or more rules to populate the fields with appropriate interaction data and metadata. Once the sections of the template are populated, the system combines the completed fields to form a prompt to present to the machine learning model.

Generating the prompt may include determining performance metadata for the interactions (Operation 217). The performance metadata may be calculated based on the interaction metadata. For example, the system may determine a response time based on a time an service inquiry was received from a customer and a time an agent communicates a response to the inquiry. The system can sum the respective number of times that customer messaged before receiving a response, a number of transfers, and/or a number of agents involved in a particular interaction.

Additionally, the system may determine sentiment scores and/or sentiment classifications by identifying moments in the interactions logged by the system. Identifying moments may include determining if the interactions include events, such as response times, agent transfers, or escalations, or meet predefined threshold values. For example, the system may identify a movement instance when a customer was transferred between agents for a third time in a single interaction. Determining the moments may also include identifying positive or negative sentiments associated with the moments using sentiment analysis. The LLM applies sentiment analysis techniques to classify sentences or phrases in an interaction as positive or negative. Positive and negative sentiments may be identified by recognizing specific words, phrases, and linguistic patterns associated with positivity, such as expressions of gratitude, compliments, agreement, or enthusiasm. For instance, the LLM may identify positive terms and phrases, such as “great,” or “You did an excellent job.” Likewise, the LLM may identify negative terms and phrases, such as “terrible,” and “That is unacceptable,” and “I'm very frustrated.” The model uses attention ranking techniques to weigh the importance of surrounding words and phrases in context. The model then identifies the corresponding moments in the customer interactions.

Generating the prompt may include determining a first portion of the prompt based on the interactions (Operation 219). One or more embodiments obtain information for the first portion based on context information of the interaction. The context information may include, for example, a customer identification, customer profile information, agent identification, customer profile information, a date/time of the interaction, type of interaction, type of product or service, urgency of the interaction, and text extracted from the interaction. Generating the prompt may include determining a second portion of the prompt based on the performance metadata of the interactions (Operation 221). As noted above, the system may determine the performance metadata by calculating one or more of customer effort, response times, sentiment scores, sentiment classifications, number of agent transfers, number of escalations, resolution time, and customer effort score.

FIG. 3A illustrates an example prompt template 301 including one or more content fields 303, context fields 305, and performance fields 307. The content fields 303 are filled with information that define parameters guiding the scope, size, and/or content of a question to be generated. The context fields 305 are filled with information describing the interaction, such as customer information (e.g., customer identification and profile), agent information (e.g., agent information and profile), service request information (e.g., time, date, product/service, communication channel) and content (e.g., extracted text). The performance fields 307 are filled with performance metadata describing the performance of the interaction. The performance metadata may include response times, sentiment scores, sentiment classifications, number of agent transfers, number of escalations, resolution time, and customer effort score.

Referring back to FIG. 2B, the system determines the personalized survey questions for the service request by submitting the prompt to the LLM (Operation 223). The LLM can be a general model, such as GPT or BERT, or the LLM can be a specialized model trained to generate satisfaction surveys in response to prompts describing interactions and metadata of the service request. The personalized survey questions may use a variety of question types corresponding to the occurrences identified in the prompt. For example, based on metadata indicating the customer was transferred between more than three agents, the survey may ask a Likert Scale question, such as “On a scale of 1 to 5, how frustrated were you with the number of agents that handled your issue?” Also, based on an interaction with a particular agent named “Smith” in which the customer expressed, “I'm very frustrated,” the survey may ask an open-ended question, such as “Please explain why you became frustrated with Agent Smith.” As a non-limiting example, FIG. 3B illustrates a personalized survey question 311 generated by the LLM based on the example prompt template 301 illustrated in FIG. 3A.

The system generates a survey including the personalized survey questions (Operation 225). Generating the survey may include adding the personalized survey question into a form for distribution to the customer. For example, the system may convert the questions into an interactive web-based form along with instructions. The generated survey may include a combination of generic survey questions and the personalized survey questions. As a non-limiting example, FIG. 3C illustrates a survey 321 generated by the system that includes the personalized survey question 311 combined with generic survey questions 323. Generic survey questions are directed to the customer's overall experience but lack references to any particular moments or events in an interaction. A generic survey question may be a multiple choice question, such as “How likely are you to buy our product again? Very, Somewhat, Unlikely or Never.”

Generating the survey may also include comparing the personalized survey questions generated by the LLM to survey questions previously provided to the customer (Operation 227). The system retrieves historical survey data associated with the customer from the database of service requests and compares the generated survey questions to the retrieved survey data. The analysis may include converting the survey questions into a standardized format, normalizing the text by removing any variations in phrasing or formatting, and applying NLP techniques to interpret the meaning of the questions.

Generating the survey may further include filtering out duplicative survey questions identified by the comparison (Operation 229). After identifying potential duplicates, the system removes the duplicate questions from the generated survey. This process ensures that the customer is not asked the same or very similar questions that they have already answered in previous surveys.

Referring to FIG. 2C, as indicated by off-page connector “B,” the system transmits the survey to the customer for completion (Operation 231). The survey may be transmitted using one or more communication channels. For example, the system may transmit the survey using the same communication through which the customer's messages were received.

Responsive to receiving the completed survey from the customer, the system determines an overall satisfaction score for the survey and an explanation of the satisfaction score using the trained machine learning model (Operation 233). The system can extract survey questions from the survey and the corresponding responses as attributes. In some cases, the content of surveys may include narrative responses to open-ended survey questions. The system extracts attributes from content from conversations using NLP techniques in a same or similar manner to that previously described. The system then computes feature vectors using the attributes and applies the machine learning model to the feature vector to generate a satisfaction score based on patterns learned by the machine learning model during training. In addition to calculating the satisfaction score, the system generates an explanation of how the score was derived. This explanation may include a breakdown of the elements that contributed to the score, such as high or low ratings on questions, the impact of specific comments made by the customer, and the relative importance of the elements as learned by the machine learning model during training.

The system stores the completed survey, the satisfaction score, and explanation determined by the machine learning model in association with the logged service request (Operation 235). The stored information is indexed alongside other service request details, such as customer information, request type, and resolution status, enabling comprehensive tracking and historical analysis of service interactions.

The system applies the satisfaction score as training data for another machine learning model (Operation 237). The system may use the satisfaction score, interaction data, and metadata as components of the training data for other machine learning models. The satisfaction score may serve as data, a label, or a target outcome in the training process. Interaction data may provide context for customer interactions that led to the satisfaction score. Additionally, the metadata may provide context for operational aspects of how the service request was handled. Together, these elements form training data from which the machine learning model may learn identify patterns, correlations, and features that contribute to making recommendations. By training the model on the survey data, the system enables the model to generate predictions or insights about future products, services, and/or marketing decisions.

### 6. EXAMPLE OF PROMPT ENGINEERING AND SURVEY GENERATION

An example embodiment is described below for purposes of clarity. Components and/or operations described below should be understood as one specific example that may not be applicable to certain embodiments. Accordingly, components and/or operations described below should not be construed as limiting the scope of any of the claims.

In the non-limiting example, the system may be a customer service system involving communications between customers and customer service agents of a service entity related to an incident. The system tracks a service ticket that associates conversations and other interactions related to a lifecycle of an incident. The incident information may be stored in a container that logs the interactions between a customer and a customer service representative. Additionally, the information includes internal communications among agents about the ticket, steps taken to resolve the ticket, a timeline of the interactions, the customer name, and service history, etc.

The system may provide the relevant information from the ticket to a machine learning model trained to construct a prompt for an LLM. The LLM processes the prompt to generate a customer satisfaction survey about the customer's experience that is specific to the customer's incident. The ticket information can include customer details, incident details, changes in status, positive or negative sentiments, or metadata exceeding thresholds. For example, if an interaction involved multiple agents, the system may generate a prompt incorporating metadata that cause the LLM to generate a question about the customer experience as it relates to that interaction. Similarly, if the ticket includes agent notes indicating an occurrence of customer frustration, the system may generate a prompt incorporating sentiment metadata that cause the LLM to generate a question about those experiences. For example, as illustrated by the prompt template 301 in FIG. 3A, the example prompt includes context fields 305 from an interaction indicating customer dissatisfaction with an item missing from an order (e.g., “I am very unhappy”). Additionally, the example prompt 301 includes performance fields 307, indicating a sentiment score of −0.8 and a sentiment classification of “strong negative” for the interaction. Based on context data 305 and the performance fields 307 in the example prompt template 301, the LLM generates a personalized survey question 311 directed to the interaction as illustrated in FIG. 3B.

Rather than solely asking generic questions, the system generates surveys that reference specific moments of the interaction or events and requests feedback about those specific moments. As described above, the LLM can generate survey questions selected from a variety of question types based on events and performance handling of the ticket. Additional prompt engineering can be done to add generic or unspecific questions as well as specify the total number of questions and types of questions, etc. Sample surveys or questions could also be provided to the LLM for reference as part of the prompt.

After the survey is generated by the LLM, the system sends the survey to the customer. In response to receiving the completed survey from the customer, the system analyzes the survey results using a machine learning model trained to generate a normalized score that allows comparison of the score across the interactions. For example, the system may engineer a prompt to have the LLM analyze the end user's responses, including tone and sentiment of any open-ended responses, and generate a score between 1 and 5 that represents the customer's overall satisfaction with the interactions. The prompt could also ask the LLM to explain how it arrived at that number. This score and explanation may then be stored alongside the customer's responses in the system.

### 7. MACHINE LEARNING ARCHITECTURE

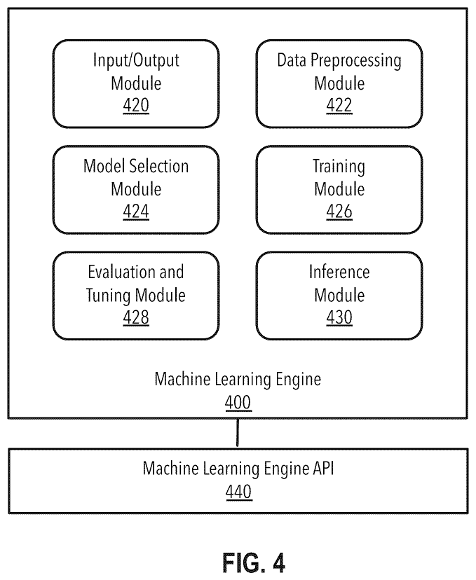

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, application program interfaces (APIs), file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training machine learning models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

FIG. 2 illustrates the operation of a machine learning engine in one or more embodiments. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training machine learning models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. The machine learning engine API 440 may feature a variety of endpoints, each tailored to a specific function within machine learning engine 400. In an embodiment, endpoints such as/submitData facilitate the submission of new data for processing, while/retrieveResults is designed for fetching the outcomes of data analysis or model predictions. The machine learning engine API 440 may also include endpoints like/updateModel for model modifications and/trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

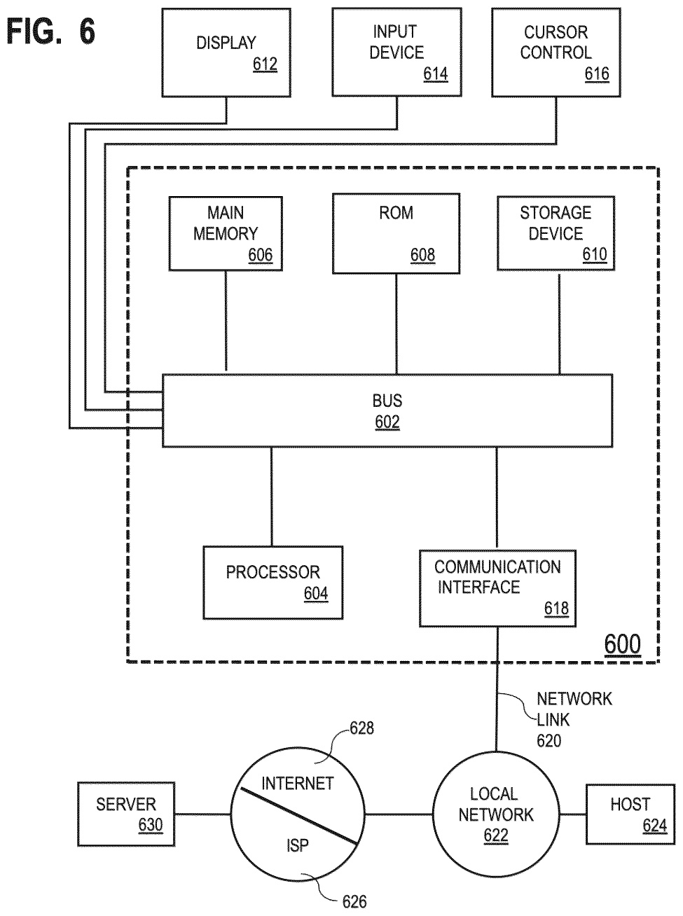

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infrared data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
receiving a first electronic message from a particular customer including a service request;
storing one or more records comprising a log of (a) a plurality of interactions associated with the service request and (b) performance metadata corresponding to the plurality of interactions;
responsive to a trigger event, generating a large language model (LLM) prompt to generate a personalized survey question, at least by:
generating a first portion of the LLM prompt based on the plurality of interactions;
generating a second portion of the LLM prompt based on the performance metadata;
applying the first portion of the LLM prompt and the second portion of the LLM prompt to an LLM prompt template, to obtain the LLM prompt;
submitting the LLM prompt to an LLM to obtain a personalized survey question for the customer;
generating a survey comprising the personalized survey question; and
transmitting the survey to the customer for completion.

2. The one or more non-transitory computer readable media of claim 1, wherein
the performance metadata comprises sentiment metadata corresponding to the plurality of interactions; and
the operations further comprise identifying a target interaction from the plurality of interactions based on the sentiment metadata.

3. The one or more non-transitory computer readable media of claim 2, wherein generating the LLM prompt comprises specifying the target interaction, the sentiment metadata corresponding to the target interaction, and the performance metadata corresponding to the target interaction.

4. The one or more non-transitory computer readable media of claim 1, wherein generating the survey comprises:
comparing the personalized survey question to previous survey questions for the customer; and
based on the comparing, combining the personalized survey question with one or more predetermined survey questions.

5. The one or more non-transitory computer readable media of claim 1, wherein generating the LLM prompt comprises specifying a selection of a survey question format for the personalized survey question from a set comprising: a Likert Scale, a binary, multiple choice, or open-ended.

6. The one or more non-transitory computer readable media of claim 1, wherein the performance metadata comprises one or more of the following: sentiment score, response time, number of transfers, number of escalations, number of agents, or response interval.

7. The one or more non-transitory computer readable media of claim 1, wherein the operations further comprise:
responsive to receiving a completed survey from the customer, applying a machine learning model to the completed survey to determine an overall satisfaction score for the survey and an explanation of the overall satisfaction score.

8. The one or more non-transitory computer readable media of claim 7, wherein the operation further comprise:
updating a training dataset for a machine learning model with the overall satisfaction score; and
applying the updated training dataset to a machine learning algorithm to train the machine learning model.

9. The one or more non-transitory computer readable media of claim 8, wherein updating the training dataset for the machine learning model with the overall satisfaction score comprises:
for individual survey questions of a plurality of survey questions include in the survey, determining a type of survey question and a response to the survey question; and
associating types of survey questions and the responses to the survey questions with the overall satisfaction score.

10. A method comprising:
receiving a first electronic message from a particular customer including a service request;
storing one or more records comprising a log of (a) a plurality of interactions associated with the service request and (b) performance metadata corresponding to the plurality of interactions;
responsive to a trigger event, generating a large language model (LLM) prompt to generate a personalized survey question, at least by:
generating a first portion of the LLM prompt based on the plurality of interactions;
generating a second portion of the LLM prompt based on the performance metadata;
applying the first portion of the LLM prompt and the second portion of the LLM prompt to an LLM prompt template, to obtain the LLM prompt;
submitting the LLM prompt to an LLM to obtain a personalized survey question for the customer;
generating a survey comprising the personalized survey question; and
transmitting the survey to the customer for completion,
wherein the method is performed by at least one device including a hardware processor.

11. The method of claim 10, wherein:
the performance metadata comprises sentiment metadata corresponding to the plurality of interactions; and
the method further comprises identifying a target interaction from the plurality of interactions based on the sentiment metadata.

12. The method of claim 11, wherein generating the LLM prompt comprises specifying the target interaction, the sentiment metadata corresponding to the target interaction, and the performance metadata corresponding to the target interaction.

13. The method of claim 10, wherein generating the survey comprises:
comparing the personalized survey question to previous survey questions for the customer; and
based on the comparing, combining the personalized survey question with one or more predetermined survey questions.

14. The method of claim 10, wherein generating the LLM prompt comprises specifying a selection of a survey question format for the personalized survey question from a set comprising: a Likert Scale, a binary, multiple choice, or open-ended.

15. The method of claim 10, wherein the performance metadata comprises one or more of the following: sentiment score, response time, number of transfers, number of escalations, number of agents, or response interval.

16. The method of claim 10, further comprising:
responsive to receiving a completed survey from the customer, applying a machine learning model to the completed survey to determine an overall satisfaction score for the survey and an explanation of the overall satisfaction score.

17. The method of claim 16, wherein further comprising:
updating a training dataset for a machine learning model with the overall satisfaction score; and
applying the updated training dataset to a machine learning algorithm to train the machine learning model.

18. The method of claim 17, wherein updating the training dataset for the machine learning model with the overall satisfaction score comprises:
for individual survey questions of a plurality of survey questions include in the survey, determining a type of survey question and a response to the survey question; and
associating types of survey questions and the responses to the survey questions with the overall satisfaction score.

19. A system comprising:
at least one device including a hardware processor;
the system being configured to perform operations comprising:
receiving a first electronic message from a particular customer including a service request;
storing one or more records comprising a log of (a) a plurality of interactions associated with the service request and (b) performance metadata corresponding to the plurality of interactions;
responsive to a trigger event, generating a large language model (LLM) prompt to generate a personalized survey question, at least by:
generating a first portion of the LLM prompt based on the plurality of interactions;
generating a second portion of the LLM prompt based on the performance metadata;
applying the first portion of the LLM prompt and the second portion of the LLM prompt to an LLM prompt template, to obtain the LLM prompt;
submitting the LLM prompt to an LLM to obtain a personalized survey question for the customer;
generating a survey comprising the personalized survey question; and
transmitting the survey to the customer for completion.

20. The system of claim 19, wherein
the performance metadata comprises sentiment metadata corresponding to the plurality of interactions;
the operations further comprise identifying a target interaction from the plurality of interactions based on the sentiment metadata; and
generating the LLM prompt comprises specifying the target interaction, the sentiment metadata corresponding to the target interaction, and the performance metadata corresponding to the target interaction.
